(19) United States
(12) Patent Application Publication
(10) Pub. No.: US 2016/0107084 A1
(43) Pub. Date: Apr. 21, 2016

(54) METHOD FOR SCAVENGER HUNT GAME

(71) Applicant: SNAPWIN S.A.P.I. de C.V., Polanco (MX)

(72) Inventors: Manuel Hernandez Kuri, Col. Lomas Altas (MX); Luis Hernandez Kuri, Col. Lomas Altas (MX)

(21) Appl. No.: 14/516,921

(22) Filed: Oct. 17, 2014

(51) Int. Cl. A63F 13/35

(52) U.S. Cl. CPC A63F 13/35

(57) ABSTRACT

Snapwin is a mobile app game. The game is related to a method for managing a contest with a processing or mobile device. Players may be searched in the mobile device's address book, through Facebook's API, Random selection from the user's Data Base or searching by username. The game creator may erase a player to substitute him in case he invited him by mistake or the player does not answer the request. Once all the players accept the invitation to the game the server creates a new game and selects a plurality of words from the data base to form a new game. These words may refer to a noun, action, verb, emotion, advertised words or whatever that can be captured and will appear in the home screen as a new game in which all the involved players must then take a photo related to that word and submit it. The player that is first to take all the photos without getting any revoked wins the game. Users are rewarded with virtual coins that may be used later in the Snapwin Store to get more game cheats, or third party coupons and discounts. The photos submitted may be liked, commented, shared or reported as abusive. Players may earn virtual coins for receiving “likes” in their photos. Games may be sponsored, as well, and the winner may be rewarded with a special prize that accompanies a “premium” word.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

A scavenger hunt is a game in which the organizers prepare a list defining specific items, which the participants—individuals or teams—seek to gather all items on the list or perform tasks or take photographs of the items, as specified.

The goal is usually to be the first to complete the list, although in a variation on the game players can also be challenged to complete the tasks on the list in the most creative manner.

Internet scavenger hunts invite participants to visit different websites to find clues and solve puzzles, sometimes for a prize. The first internet hunt was developed in 1992 by Rick Gates to encourage people to explore the resources available online.

A mobile app is a computer program designed to run on smartphones, tablet computers and other mobile devices. Apps are usually available through application distribution platforms, which began appearing in 2008 and are typically operated by the owner of the mobile operating system. The term “app” is a shortening of the term “application software”.

A mobile game is a video game played on a feature phone, smartphone, PDA, tablet computer, portable media player or calculator. This does include games played on dedicated handheld video game systems.

The first game, Tetris, was on a mobile phone and was released in 1994. Three years later Nokia launched the Snake, starting in December 1997. Snake and its variants, that were preinstalled in all mobile devices manufactured by Nokia, has since become one of the most-played video games and is found on more than 350 million devices worldwide. A variant of the Snake game for the Nokia 6110, using the infrared port, was also the first two-player game for mobile phones.

Now, mobile games are usually downloaded via the mobile operator's network, but in some cases are also embedded in the handheld devices by the OEM or by the mobile operator when purchased, via infrared connection, Bluetooth®, memory card or side loaded onto the handset with a cable.

Typically, mobile games use one of the following business models: pay-per-download, subscription, free-to-play or advertising. Until recently, the main option for generating revenues was a simple payment on downloading a game. Subscription business models also existed and had proven popular in some markets. Today, a number of new business models have emerged which are often collectively referred to as “freemium”. The game download itself is typically free and then revenue is generated after download either through in-app transactions or advertisements.

### SUMMARY OF THE INVENTION

The game of the present invention shall be called “Snapwin” herein. Snapwin is a scavenger hunt game similar to the method disclosed in U.S. Pat. No. 5,942,969 and U.S. Pat. No. 6,102,406 in which a set of individuals join a game to play remotely from a mobile device connected to the internet, thanks to a method, similar than the one disclosed in U.S. Pat. No. 5,643,088 where the game keeps running in the background and players receive a set of clues to begin the game.

Snapwin's “clues” may be referred as “instructions” similar to the method disclosed in U.S. Pat. No. 6,312,337 and these “instructions” are shown as words (referred to herein as “items”) generated by the system or by the players in the game. This list of items may refer to actions, verbs, nouns, objects, situations, emotions or anything that could be photographed with the device. The items do not need a GPS location validation, visited websites or answer any questions to be revealed. To play, the game asks the players to take a photograph of every item in the game, similar to the method disclosed in U.S. Pat. No. 6,312,337, but without any fee to participate.

Snapwin specifically asks for a photograph of a representation of each item in the game; for example golf ball, jumping girl or family gathering. The main goal of the game is to be accurate in representing those items in photos. The game won't show any popup or advertisement to the player. However the words in play may also represent an advertised word, like a brand or a product. This word will appear as part of the game, the only difference is that this word is appearing because someone paid for it to appear. Starbucks coffee for instance.

Each player must take a photo in the app of each item to complete the list. The players may not see each other's photo of a specific word until after they took their own. After one of the players completes the set of pictures, similar to the method disclosed in U.S. Pat. No. 6,312,337, the app must evaluate a possible winner. This evaluation is made by the players which must determine if the set of photos are in fact referring to the words in play.

As players take their photographs, they may see other player's entries and they get the chance to vote to revoke other's photographs if they feel they do not represent what the item is. If the majority of the players votes to revoke a photograph, then the photo is erased and the item is back on that players' game. If a player takes all of the photos of the items on the assigned list and none of the pictures is voted to be revoked, then that player wins.

As a difference from U.S. Pat. No. 5,942,969, Snapwin's players decide whether the picture is or is not the representation of the clue, in this case the item. All of the other players may also receive points for the words they photographed as compensation, even though their game is incomplete. This is similar to the method disclosed in U.S. Pat. No. 6,312,337 that mentions that more than one player can be rewarded. Their reward depends on the value of the word they took a photo of.

Thanks to a method similar than the one disclosed in U.S. Pat. No. 6,312,337. Snapwin elaborated a game specifically to represent items through images. Snapwin does not compare submissions with pre-determined photographs and the server does not determine a winner by itself. The users may interpret a word in any way they want. For example a “hotdog” may be food or a dog under the sun. It's the creativity that matters.

The game offers cheats in exchange of virtual coins. These cheats may be used either to upload a picture from the camera roll or to eliminate a word from the list. The photo from the camera roll may be one taken in the past or a picture saved from the internet. This last method relates to U.S. Pat. No. 6,102,406, but Snapwin does not require one to visit any webpage in particular. This is just an alternative to the player. Snapwin lets you use one cheat per game only, regardless of the amount of cheats you may have.

If one player appears in a photo taken in the game, Snapwin lets you tag that player in that photo. As a difference in U.S. Pat. No. 7,258,614, this tag system is only for the purpose of social networking and does not interfere with the game mode.

The winner of the game, gets virtual coins. Coins build up to eventually allow the player to purchase cheats or special promotions with third party apps or services.

In the future, Snapwin might support the ability of users to determine whether a photo is legitimate and represents the word in play by using a similar method to the one disclosed in U.S. Pat. No. 7,565,139 which helps identify an image with a description. Snapwin may also use Geotagging in order to remind users where their photos were taken or to use metadata for other uses, similar to the method disclosed in U.S. Pat. No. 4,144,232 addresses.

Snapwin may ask users to take video referring to the items in play in the future. It may also show items as images or videos besides words asking users to replicate them.

The advertised words might be managed using a web app system, similar to the method disclosed in U.S. Pat. No. 8,401,887 to let advertisers control their campaigns and assign words to games specifying period of time, budget, user segmentation by age, gender and location groups.

In the future, users may determine the items to play by submitting them. It is contemplated that each of the users will submit a word and a new game will start using words submitted by the users. This proposed game mode uses a methodology that is similar to U.S. Pat. No. 8,425,291, but Snapwin does not involve any complex algorithm to create new rules. Instead, user entries are key.

### DESCRIPTION OF THE DRAWINGS

The features, objects and advantages of the game comprising the present invention will be apparent to persons of ordinary skill in the art from the following detailed description thereof, especially with the aid of the accompanying drawings in which:

FIG. 1 is a flow chart of the scavenger hunt game;

FIG. 2 is a flow chart of a feature of the game where advertised words are provided;

FIG. 3 is a flow chart reflecting how a player may be automatically compensated for producing photos meeting predetermined requirements;

FIG. 4 is a block diagram of the network by which a game can be created; and

FIGS. 5A-5K depict screen prints that appear on player's mobile devices at various stages of game play;

FIG. 6 is a flow chart of an alternative embodiment to that illustrated in FIG. 2, and more specifically, one in which the words are not necessarily advertising words.

### DESCRIPTION OF THE PREFERRED EMBODIMENTS

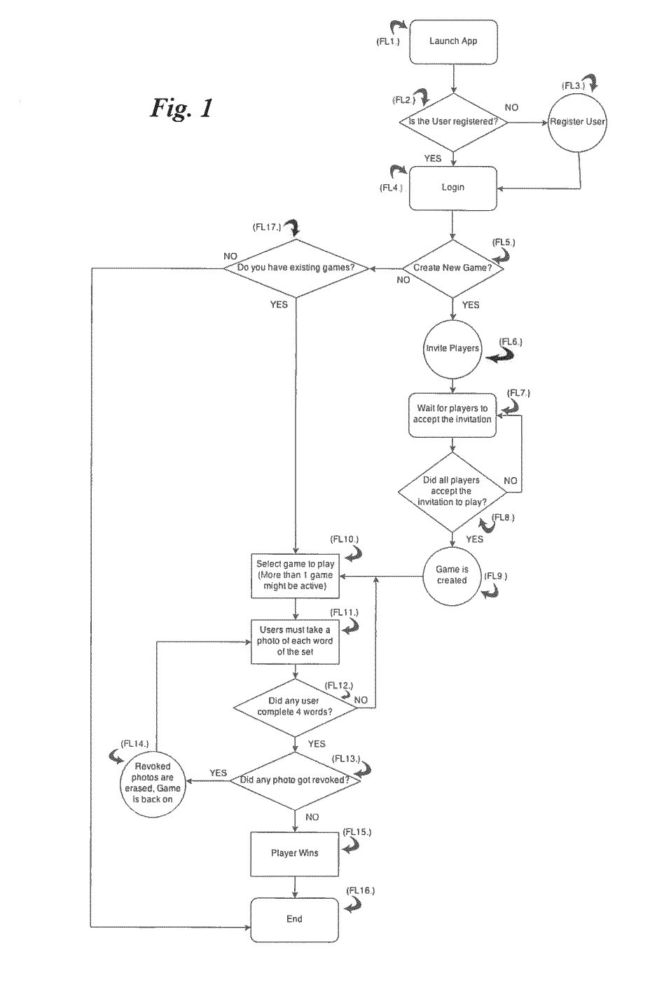

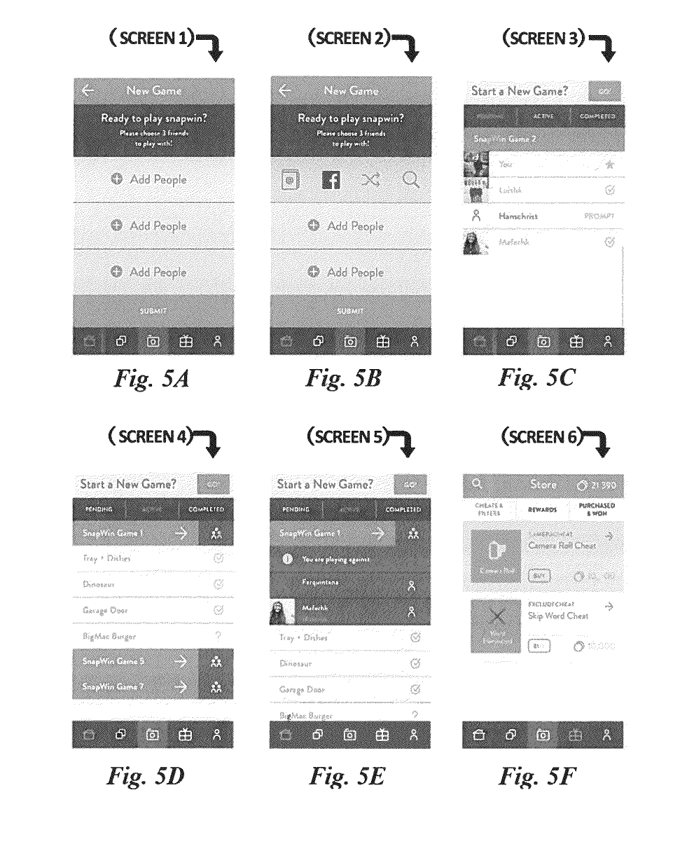

Before presenting a detailed description of the method of playing the game of the present invention, it is deemed beneficial to generally describe the flow charts of FIGS. 1-4 and the display screens of FIGS. 5A and 5B.

### General Description of the Flow Charts and Screens

### FIG. 1

### Game Flowchart

### FL1. Launch App

Snapwin app is installed, opened and starts running in the mobile device.
FL2. Is the user registered?
Snapwin shows a “Log in/Sign up” screen so that the user may identify. If the user does not have an account, the app takes him to step FL3. Otherwise the app takes the user to Step FL4.

### FL3. Register User

The user that does not have an account in Snapwin must register to obtain one. The user must enter a user name, an email, a date of birth and agree to recognize his current location. The location is important to classify the available items at the store. After registering, the app takes the user to step FL4.

### FL4. Log in

Either if the user logs in with an existing account or registers for a new one, the app checks the credentials in the database and logs the user into Snapwin. Then, the user is taken to the home screen of the app, where he may find/create games.
FL5. Create new game
Snapwin asks you to start a new game. If the user wants to start a new game then the app takes you to step FL6. If the user does not want to start a new game then the app might have existing or open games in step FL17.
FL6. Invite players
Snapwin shows a screen to invite other users to join a game. Users may be invited through the devices address book, facebook friends (the user must allow facebook's API to connect with Snapwin), through a random selection from the Snapwin's user database or searching by username. Once the desired players are selected the game leader may send an invitation as a push notification to accept the game.
FL7. Wait for players to accept the Invitation
After sending invitations to a number of users to join a game, the list of invited users is shown in the “pending” area of the home screen. The game creator must wait until all players accept the invite.
FL8. Did all players accept the invitation to play?
The app waits until all the invited players accepts the invitation to play. The game creator may erase invites and replace users. This may happen if one or more of the invited players takes too much time to accept. If the players do not accept the game then the game creator may cancel the game or wait for the response until they accept in step FL7.
FL9. Game is created
When all invited users accept the game, the app creates a new game and players receive a push notification. This new game contains a set of items in a list to photograph. All the players may now start playing. The game stays open in the background even though a player closes the app.
FL17. Do you have existing games?
Once a player enters Snapwin the home screen will show if there are existing games. If so he may select one and play on step FL10. If not he may either create a new game in step FL5 or exit the app to step FL16.
FL10. Select game to play
If the user created one or more games in step FL9, he must select one to start playing. Users may play more than one game simultaneously, but they must select one to submit their entries. After selecting a game he must follow to step FL11.
FL11. Users must take a photo of each word on the set
Each game will show a set of items of which the user must take a photograph. These items may be objects, actions, nouns or whatever that can be represented visually.
When a player submits an entry, other players are notified. A player may not see other players' entries until he submits his own. Users may vote to revoke a photo that they believe does not represent the item it was supposed and is taken to step FL14.
FL12. Did any of the users completed the set of words?
When a user photograph all the set of words in the game he is declared a winner and continues to step FL15, unless one of his pictures get revoked by the majority of the other players.
FL13. Did any photo got revoked?
All the players have a time lapse to vote to revoke a submitted photo. If the majority of the players vote to revoke a photo, then the photo is erased and continues to step FL14. If none of the photos is revoked then the player wins and play continues to step FL15.
FL14. Revoked photos are erased. Game is back on.
If one or more of a player's photo is revoked by the majority of the players, then that photo is erased and the word is back in the game.

### FL15. Player Wins

When a player takes a photograph of all of the set of words in a game without getting one revoked, the user is declared as a winner. The user gets virtual coins for each of the word's value, plus a bonus for winning in first place. All of the other users may win compensation virtual coins for the value of the photos that they took. At the end of the game, all photos are stored in the players' personal galleries and might be seen by other Snapwin users. All users win a certain amount of virtual coins when another user “likes” a photo in their gallery.

### FL16. End

The game ends. User might continue playing if they had more opened games.

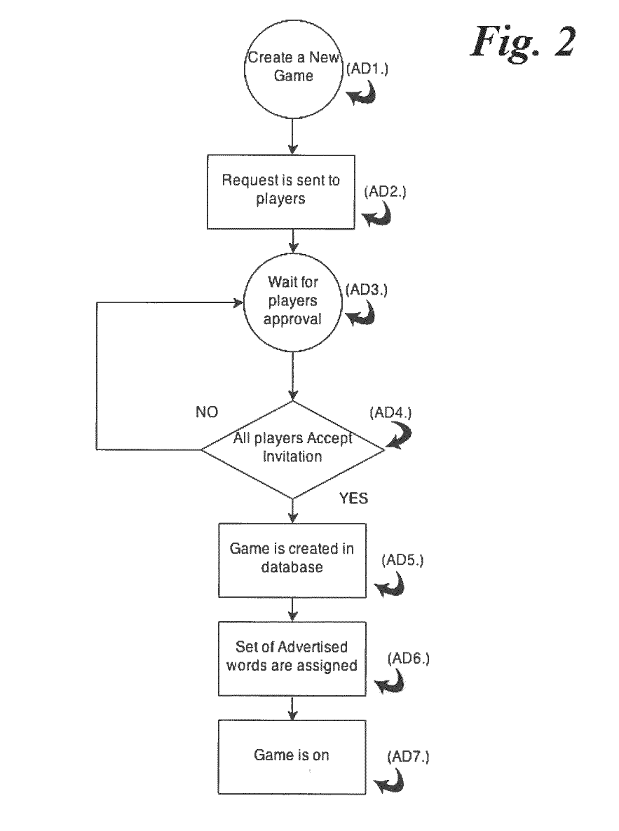

### FIG. 2

### Advertised Words

AD1. Create a new game
Snapwin asks one to start a new game. If the user wants to start a new game then he or she must invite other users to play and the app takes the player to step AD2.
AD2. Request is sent to players
Snapwin shows a screen to invite other users to join a game. Users may be invited through the devices address book, facebook friends (the user must allow facebook's API to connect with Snapwin), through a random selection from the Snapwin's user database or searching by username. Once the desired players are selected the game leader may send an invitation as a push notification to accept the game.
AD3. Walt for players' approval
After sending invitations to a number of users to join a game, the list of invited users is shown in the “pending” area of the home screen. The game creator must wait until all players accept the invite.
AD4. Did all players accept the invitation?
The app waits until all the invited players accepts the invitation to play. The game creator may erase invites and replace users. This may happen if one or more of the invited players takes too much time to accept. If the players do not accept the game then the game creator may cancel the game or wait for the response until they accept in step AD3.
AD5. Game is created in the data base
When all invited users accept the game, the app creates a new game in the data base and players receive a push notification. This new game contains a set of items in a list to photograph. All the players may now start playing. The game stays open in the background even though a player closes the app.
AD6. Set of Advertised Words are assigned
The data base contains a set of “premium” words, which are words advertised by brands or companies. This words may be used in games and take place of a word to photograph (e.g. Starbucks coffee instead of Black Coffee). This premium words may be used in games played by users and assigned using segmentation. Segmentation may be user's location, gender, age or other metadata. Companies or brands are charged with different monetizing models to assign advertised words in Snapwin.

### AD7. Game is on

Once the set of “standard” words and “premium” words are assigned to a game, the players are ready to start playing.

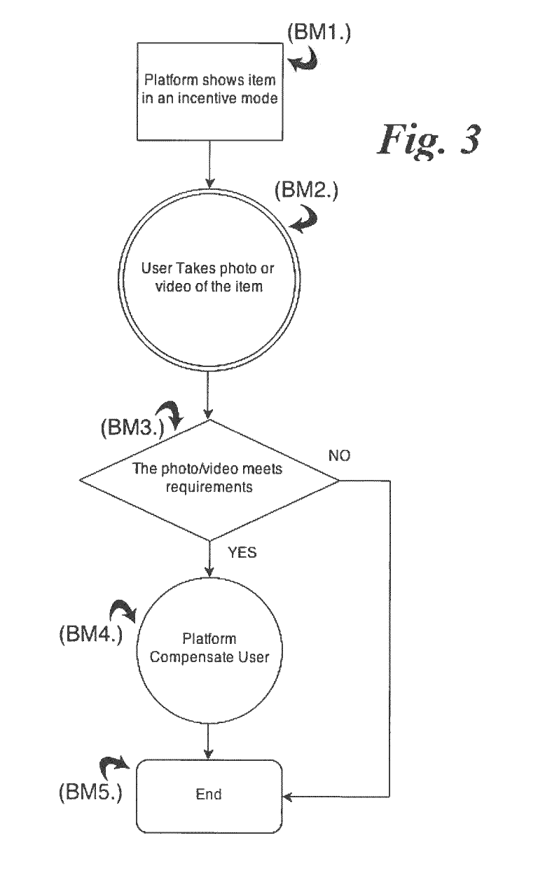

### FIG. 3

### Commercialize Method

BM1. Platform Shows Item in an incentive mode
The platform, app or system shows the user an item, word, action or instruction using an incentive mode. This incentive mode could be entertainment, a game, cash or money compensation, special discounts or any other incentive a user may find attractive.
BM2. User takes photo or video of the item
After presenting the user with the item, word, action or instruction, the user photographs or records video of a representation of it. This may be done one or more times.
BM3. The photo or Video meets requirements
If the entries submitted by the user meets the requirements specified by the system, app or platform then the user is compensated in step BM4. Otherwise the process ends and the user must try again.
BM4. Platform compensate User
The platform compensates the user for submitting entries that meet the initial requirements. This compensation might be through entertainment, game models, cash or money, special discounts or any other incentive predefined by the platform.

### BM5. End

End of the process.

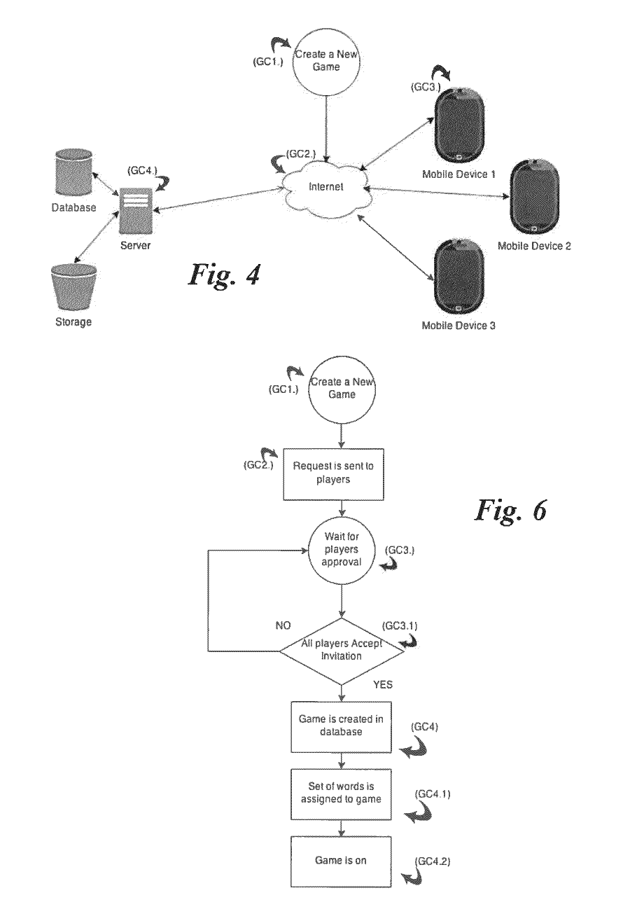

### FIG. 4

### Equipment

As illustrated in FIG. 4, the game is played on mobile devices assigned to players and capable of communicating via the internet.

The game is hosted by a server also capable of communicating via the internet. The server is able to access storage. A database stored on the storage or elsewhere is also accessible by the server.

### FIGS. 5A-5K

### Screens

### Screen 1 (FIG. 5A).

This screen let the users invite players to play. In this version you may invite from 2 to 3 players to create a 4 player game including the creator. The screen has 5 buttons in the button that represents Home, Gallery, Camera, Virtual Store and Profile.

### Screen 2 (FIG. 5B).

Players may be invited from the mobile device address book, facebook friends, random selection and using usernames.

### Screen 3 (FIG. 5C).

Invited users are shown in a pending section, where the creator must wait for their approval. The creator may send a prompt to remind the user of the game with a push notification.

### Screen 4 (FIG. 5D).

Once all the players accepted the invite to play a set of words is assigned to the game. This words are highlighted as the player submits a photo (or video in later versions).

### Screen 5 (FIG. 5E).

The players may see who they are playing against.

### Screen 6 (FIG. 5F).

The virtual store lets you redeem the virtual coins won in the game for game cheats or special offers with third party service providers or retails.

### Screen 7 (FIG. 5G).

In the game detail the users may see their entries according to the word. Each word has a value which represent a prize. Cheats may be used in this screen.

### Screen 8 (FIG. 5H).

In the view entry screen you may see other players entries and the own. If the other players have not taken a photo then a placeholder is shown. Players may only see other player's photos until they take their own. Other player's entries may be voted for revocation from this screen.

### Screen 9 (FIG. 5I).

In the photo detail view users may like, comment, share or report it.

### Screen 10 (FIG. 5J).

Each user has a personal profile page. This page shows location and a personal gallery. This gallery contains photos that were taken by user in past games. Profiles may be private or public, preventing other users from viewing it. In the profile screen a user may consult his virtual coins, game alerts and notifications, and game configurations.

### Screen 11 (FIG. 5K).

The gallery shows pictures taken by Snapwin players. My photos show a user's own photos, Friends represent past players and everyone includes the latest images submitted by all the users in Snapwin's base.

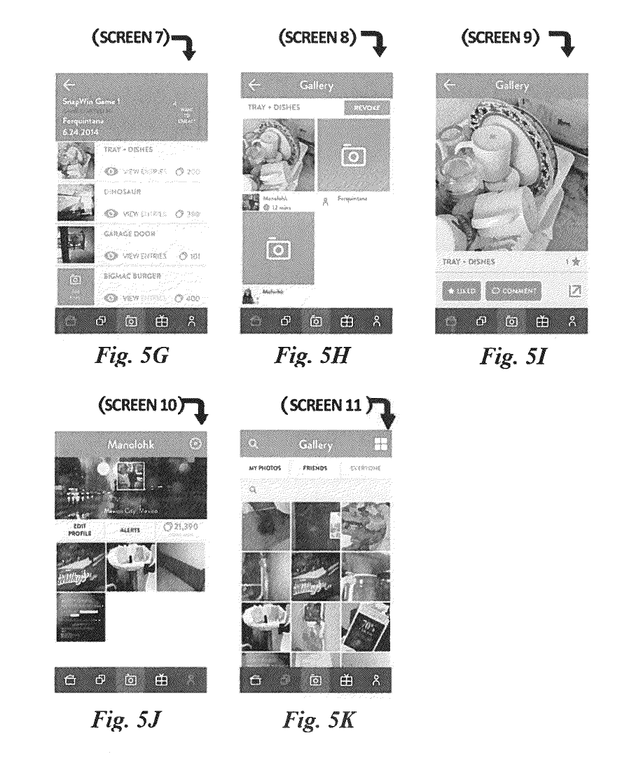

### FIG. 6

### Game Creation

### GC1. Create a New Game

Snapwin asks one to start a new game. If the user wants to start a new game then he must invite other users to play and the app takes you to step GC2.

### GC2. Internet

The mobile app sends a request through the internet to fetch from the cloud servers users information and send the data to notify users of their invitations to join a game.

### GC3. Mobile Devices

User's mobile devices receive data from the internet as invitations to play. This invitations are answered and the data is transferred again to the cloud servers in order to settle a new game, upload an entry, sends a comment, or any data in Snapwin. Invitations stay idle until users accept, cancel or are erased.
GC3.1. All players accept invitation
If all players accept invitation to play then the game is created in the database in step GC4, otherwise the process stays idle in step GC3.
GC4. Cloud Server, database, and Storage
Cloud servers process all the information that is sent by the mobile devices through the internet. Databases store user information, games information and image pointers. The storage bucket saves all hard data like images or videos. This configuration feeds all the content of Snapwin app and process all requests to be used and shown to final users.
GC4.1. Set of words is assigned to game
A set of randomized words is assigned to a game. This words are stored in the database in different languages to help user experience during the game. Words are assigned to users according their location or language preferences. Premium or advertised words are also stored in the database and may be assigned to random or specific games according to user segmentation models.

### GC4.2. Game is on

Game begins and players are ready to play.

Snapwin uses a new methodology to commercialize advertising. This method consists of asking a user to take a picture or video of an specific word, action, object or anything that may be recorded or photographed and offer the user an incentive, such as entertainment through a game mode, virtual points, real money, special offers or any way of other compensation. This mythology creates a direct engagement between the user and the product/brand.

Snapwin uses this methodology to commercialize items representing a brand or product. Snapwin receives a compensation from an advertiser for including their brand, product or anything related to it to the platform and also receives compensation for the snapped photos or recorded videos. This method may include the use of open source pattern recognition algorithms that compare pixels in order to identify logos and brands, and metadata in order to identify places where the picture was taken.

### DETAILED EXPLANATION OF THE INVENTION

Snapwin is a mobile app game. The game is related to a method for managing a contest with a processing or mobile device. When the app launches (FL1) it shows a “Log in/Sign up” screen so that the user will identify if he's registered (FL2), and it asks the user to login to his account using a username and password (FL4) or register a new one (FL3). After the user has logged in to his account, the app will display a home screen (Screen 4) in which the user will have his Pending games, opened games and completed games (FL17). If a user wants to create a new game (FL5)(AD1)(GC1) he must click on the “Go” button and the app will take him to the invite screen (Screen 1). From this screen a user may invite up to 3 more players to join the game (FL6)(AD2)(GC2). Players may be searched in the mobile device's address book, through facebook's API, Random selection from the user's Data Base or searching by username (Screen 2).

After the invitation is submitted, the user is taken back to the home screen and a pending game is created in the pending game tab (Screen 3). A push notification is sent to the invited players and the game stays idle until all the invited players accept the game (FL7)(AD3)(GC3). The game creator may erase a player to substitute him in case he invited him by mistake or the player does not answer the request (FL8).

Once all the players have accepted the invitation to the game (AD4)(GC3.1), the server creates a new game (FL9) and selects 4 words (GC4.1) from the data base to form a new game (AD5)(GC4). These 4 words may refer to a noun, action, verb, emotion, advertised words (AD6) or whatever that can be captured and will appear in the home screen as a new game in which all the involved players must now take a photo related to that word (BM2) and submit it (FL11)(Screen 4).

The users may see who they are playing against by clicking the players button (Screen 5). The app has 4 buttons in the bottom which take you to Home (Screen 4), Gallery (Screen 11), Store (Screen 6) and Profile (Screen 10). In the home screen if the user clicks on a word, the app takes him to the “view entries” screen in which he may see if other user have submitted his photo (Screen 8). Each time a user submits a photo all the players are notified in their mobile devices. The players may not see each other's photos until they have taken their own photo. They may also vote to revoke another player's photo if they think it does not relate to the word it is supposed to represent. If the majority of the players votes to revoke an entry then that photo is eliminated and the game continues.

Users may use cheats in games. These cheats include skipping a word by eliminating it from the list or by uploading a photo from their camera roll. These cheats may be used from the cheats button (Screen 7) and to acquire more cheats the user must buy them in the Snapwin Store (Screen 6).

The player that takes all the photos (FL12) without getting one revoked (FL13)(FL14) first wins the game (FL15). Users are rewarded with virtual coins that may be used later in the Snapwin Store to get more game cheats, or third party coupons and discounts (BM3). More than one player may be rewarded in games depending on the word's value. The winner of a game will receive a special winner bonus apart from the word's values.

When the game ends all the users may browse played photos in the gallery which show a user's photos, his friend's photos and everyone's photos. By “friends”, we refer to users that have played before with the user. The photos submitted may be “liked”, “commented”, “shared” or reported as “abusive”. Players may earn virtual coins for receiving “likes” regarding their photos.

One of the words in the game is categorized as a “Premium” word (AD6), which means that it is a sponsored word. Snapwin may charge to a brand or company to have a word appear in a game thereby to be advertised (e.g. Starbucks coffee). The user won't notice this advertisement because the word will be shown just as the others in the game. Games may be sponsored as well and may reward the winner with a special prize that accompanies the premium word (e.g. Starbucks coffee is the premium word and the game rewards with coins and a 10% discount in consumption).

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. A method for managing a contest with a processing device, the method comprising:
providing an app with a “Log in/Sign up” screen so that the user may identify if said user is registered (FL2), wherein the user logs in to user's account using a username and password (FL4) or registers a new account (FL3), then, after the user has logged in to his account, the app displaying a home screen (Screen 4) in which the user will have his Pending games, opened games and completed games displayed (FL17).

2. The method of claim 1 further comprising: if a user wants to create a new game (FL5)(AD1)(GC1) he must click on a “Go” button and the app will take him to the invite screen (Screen 1), wherein, from this screen a user may invite up to 3 more players to join the game (FL6)(AD2)(GC2).

3. The method of claim 2 further comprising a step wherein potential players to be invited to play may be searched in a mobile device's address book, through Facebook's APL by random selection from a user's Data Base or searching by username (Screen 2).

4. The method of claim 2 wherein after an invitation is submitted, the user is returned to a home screen and creating a pending game in the pending game tab (Screen 3), and sending a push notification to the invited players and idling the game until all the invited players have accepted the game (FL7)(AD3)(GC3).

5. The method of claim 4 wherein a game creator may erase a previously invited player and substitute such playing in case such player had been invited by mistake or if the player does not answer a request to play (FL8), and once all the players accept the invitation to the game (AD4)(GC3.1) the server creating a new game (FL9) and selecting a plurality of 4 words (GC4.1) from the data base to form a new game (AD5)(GC4).

6. The method of claim 5 wherein said plurality of words may refer to one of a noun, action, verb, emotion, advertised words (AD6) that can be captured and will appear in the home screen as a new game in which all the involved players must then take a photo related to that word (BM2) and submit it (FL11)(Screen 4).

7. The method of claim 6 wherein the users may see who they are playing against by clicking the players button (Screen 5) and wherein the app has a set of buttons which take said user to Home (Screen 4), Gallery (Screen 11), Store (Screen 6) and Profile (Screen 10).

8. The method of claim 7 wherein the home screen allows the user to click on a word, causing the app to take such user to the “view entries” screen in which such user may see if other users have submitted photos (Screen 8), and wherein each time a user submits a photo all the players are notified in their mobile devices.

9. The method of claim 8 wherein the players are allowed to see each other's photos only after such players have taken their own photos and vote to revoke another player's photo upon determining that such photo does not relate to the word it represents.

10. The method of claim 9 wherein if the majority of the players votes to revoke an entry then that photo is eliminated and the game continues and users may use cheats in games.

11. The method of claim 10 wherein said cheats include skipping a word by eliminating it from the list or uploading a photo from one's camera roll, wherein said cheats may be selected from a cheats button (Screen 7) and acquiring more cheats by buying them in a store (Screen 6), wherein the player who first takes all the photos (FL12) without getting any revoked (FL13)(FL14) wins the game (FL15).

12. The method of claim 11 wherein users are rewarded with virtual coins that may be used later in a store to get more game cheats, or third party coupons and discounts (BM3), wherein more than one player may be rewarded in games depending on a word's value, and wherein the winner of a game receives a special winner bonus apart from the word's values.

13. The method of claim 12 wherein, when the game ends, all users may browse played photos in a gallery which shows a given user's photos, his friend's photos and everyone's photos, wherein friends consists of users that have played before with said given user, wherein the photos submitted may be classified as “liked”, “commented”, “shared” or reported as “abusive”.

14. The method of claim 13 wherein players may earn virtual coins for receiving “likes” in their photos, wherein one of the words in the game is categorized as a “Premium” word (AD6), which means that it is a sponsored word.

15. The method of claim 14 wherein the app may charge to any owner of brand name or company that appears in a game as a word to be advertised.

16. The method of claim 15 wherein games may be sponsored as well and a sponsor may reward the winner with a special prize that accompanies the premium word.
